(19) United States
(12) Patent Application Publication
(10) Pub. No.: US 2026/0339354 A1
(43) Pub. Date: Oct. 29, 2026

(54) DEVICES, SYSTEMS, AND METHODS FOR IMPLEMENTING A HIERARCHICAL FRAMEWORK OF AUTONOMOUS VEHICLES

(71) Applicant: AI-ID, Inc., Reno, NV (US)

(72) Inventor: Shaunt M. Sarkissian, Reno, NV (US)

(73) Assignee: AI-ID, Inc., Reno, NV (US)

(21) Appl. No.: 19/149,282

(22) PCT Filed: Apr. 24, 2025
(86) PCT No.: PCT/US2025/026233

§ 371 Date: Jul. 18, 2025

(51) Int. Cl. G05D 1/695; B64U 10/80; B64U 20/40; B64U 101/20; G05B 17/02; G05D 109/25; G08G 5/21

(52) U.S. Cl. CPC G05D 1/695; B64U 10/80; B64U 20/40; G05B 17/02; G08G 5/21; B64U 2101/20; B64U 2201/10; G05D 2109/254

(57) ABSTRACT

A method of dynamically generating and updating commands for a cluster of autonomous vehicles to accomplish a user-defined objective within an operating environment is disclosed herein. The method can include receiving a user input associated with the user-defined objective, characterizing the user-defined objective, the cluster of autonomous vehicles, or the operating environment, generating a command for one or more vehicles of the cluster based on the characterization, transmitting the command to at least one vehicle of the cluster of autonomous vehicles, receiving sensor data associated with the cluster of autonomous vehicles, and determining whether the user-defined objective has been accomplished based on the sensor data associated with the cluster of autonomous vehicles.

### FIELD

The present disclosure is generally related to autonomous vehicles and, more particularly, is directed to the integration, communication, and distribution of artificial intelligence throughout a modular fleet of communicatively coupled vehicles, which can be specifically configured to accomplish a user-defined objective.

### SUMMARY

In some aspects, the present disclosure is directed to a method of dynamically generating and updating commands for a cluster of autonomous vehicles to accomplish a user-defined objective within an operating environment. The method can include receiving a user input associated with the user-defined objective, characterizing the user-defined objective, the cluster of autonomous vehicles, or the operating environment, generating a command for one or more vehicles of the cluster based on the characterization, transmitting the command to at least one vehicle of the cluster of autonomous vehicles, receiving sensor data associated with the cluster of autonomous vehicles, and determining whether the user-defined objective has been accomplished based on the sensor data associated with the cluster of autonomous vehicles.

In other non-limiting aspects, the present disclosure is directed to a system configured to dynamically generate and update commands for a cluster of autonomous vehicles to accomplish a user-defined objective within an operating environment. The system can include a control circuit and a memory communicatively coupled to the control circuit, wherein the memory stores a Modular Micro Cluster Drone (“MMCD”) model that, when executed by the control circuit, causes the system to receive a user input associated with the user-defined objective, characterize the user-defined objective, the cluster of autonomous vehicles, or the operating environment, or combinations thereof based on training data, generate a command for one or more vehicles of the cluster based on the characterization, establish a short range network that communicatively couples the MMCD model to at least one vehicle of the cluster of autonomous vehicles, transmit the command to the at least one vehicle of the cluster of autonomous vehicles via the short range network, receive sensor data associated with the cluster of autonomous vehicles, and determine whether the user-defined objective has been accomplished based on the sensor data associated with the cluster of autonomous vehicles.

In still other non-limiting aspects, the present disclosure is directed to a method of dynamically generating and updating commands for a cluster of autonomous vehicles to accomplish a user-defined objective within an operating environment. The method can include receiving, via a Modular Micro Cluster Drone (“MMCD”) model, a user input associated with the user-defined objective, generating, via the MMCD model, a command for one or more vehicles of the cluster based on the user input, receiving, via the MMCD model, sensor data associated with the cluster of autonomous vehicles, and determining, via the MMCD model, whether the user-defined objective has been accomplished based on the sensor data associated with the cluster of autonomous vehicles.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 illustrates a block diagram of a system for executing a user-defined objective using a modular cluster of autonomous vehicles, in accordance with at least one non-limiting aspect of the present disclosure;

FIG. 2 illustrates another block diagram of the system of FIG. 1, wherein an autonomous vehicle of the modular cluster of autonomous vehicles has been deployed to execute the user-defined objective, in accordance with at least one non-limiting aspect of the present disclosure;

FIG. 3 illustrates a bock diagram of various configurations for the system of FIG. 1, in accordance with at least one non-limiting aspect of the present disclosure;

FIG. 4 illustrates a perspective view of the cluster 100 of FIG. 1, in accordance with at least one non-limiting aspect of the present disclosure;

FIG. 5 illustrates a top view of the cluster of FIG. 1 is depicted, in accordance with at least one non-limiting aspect of the present disclosure;

FIGS. 6A and 6B illustrate sectioned side views of one of the autonomous vehicles of the cluster of FIG. 1, in accordance with at least one non-limiting aspect of the present disclosure;

FIGS. 7A and 7B respectively illustrate side views of two autonomous vehicles of the cluster of FIG. 1 before and after deployment, in accordance with at least one non-limiting aspect of the present disclosure;

FIG. 8 illustrates a perspective view of a first autonomous vehicle of the cluster of FIG. 1, in accordance with at least one non-limiting aspect of the present disclosure;

FIGS. 9A and 9B respectively illustrate a top and side view of the autonomous vehicle of FIG. 8, in accordance with at least one non-limiting aspect of the present disclosure;

FIG. 10 illustrates a perspective view of a second autonomous vehicle of the cluster of FIG. 1, in accordance with at least one non-limiting aspect of the present disclosure;

FIGS. 11A and 11B respectively illustrate a top and side view of the autonomous vehicle of FIG. 10, in accordance with at least one non-limiting aspect of the present disclosure;

FIG. 12 illustrates a port configured to mechanically and electrically couple any of a plurality of modular, interchangeable payloads to the vehicles of FIGS. 8 and 10, in accordance with at least one non-limiting aspect of the present disclosure;

FIGS. 13A-F illustrate several modular, interchangeable payloads configured for use with the port of FIG. 12, in accordance with at least one non-limiting aspect of the present disclosure;

FIG. 14 illustrates a method of dynamically generating and updating commands for one or more autonomous vehicles within a cluster based on real-time sensor data, in accordance with at least one non-limiting aspect of the present disclosure; and

FIG. 15 illustrates a method of training and using an algorithmic model to perform the method of FIG. 14, in accordance with at least one non-limiting aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms.

As used herein, a “platform” shall include an environment where software is executed. A platform can include the hardware, operating systems, and associated application programming interfaces, or other underlying software. A platform can include a control circuit (e.g., such as a processor, microprocess, or logic-based device, such as an application specific integrated circuit, as well as a memory configured to store software and/or instructions to be executed by the control circuit. A platform can provide the infrastructure and thus, foundation on which the devices, systems, and methods disclosed herein can be implemented to provide digital services, applications, and data processing functionality. It shall be appreciated that, according to some non-limiting aspects, a platform can include a client-server architecture, utilized to establish the requisite technical relationships between cooperating programs and for the deployment of a distributed application.

Before explaining various aspects of the devices, systems, and methods disclosed herein, it should be noted that the illustrative examples are not limited in application or use to the details disclosed in the accompanying drawings and description. It shall be appreciated that the illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof.

Autonomous vehicles, such as drones, have increased in popularity for various reasons. For example, technology has advanced such that the necessary components, such as batteries (e.g., lithium polymer, lithium ion, nickel metal hydride, nickel cadmium, etc.), motors (e.g., brushless direct current, brushed direct current, alternating current motors, etc.), global positioning system (“GPS”) components, and/or propellers have become smaller, lighter, and more affordable. These advancements have resulted in drones being more accessible and adapted for various civilian, commercial, and/or governmental applications. However, to the extent that conventional drones are implemented to accomplish user-defined objectives, such drones are only configured to operate as standalone units or under a centralized control framework. Indeed, conventional drones lack the ability to dynamically collaborate with other autonomous vehicles in real-time and exhibit limited autonomy based on a limited array of onboard sensors, and operate without the capacity for inter-drone communications or distributed intelligence. As a result, such drones are incapable of flexibly interpreting or responding to complex, user-defined mission objectives—particularly those that require adaptive coordination, environmental awareness beyond their own sensor range, and delegation of tasks across multiple units.

Additionally, conventional drones lack a hierarchical or mesh communication structure and lack differentiated capabilities among units within a system. This can restrict scalability and resilience. In environments where communication with a centralized ground station is disrupted or where mission parameters evolve dynamically, current drones cannot reassign roles, synthesize shared sensor data, or adjust strategy based on real-time conditions. These limitations significantly reduce operational efficiency, robustness, and the ability to perform multi-node tasks required to accomplish a number of user-defined objectives using a cluster of drones. Such technological deficiencies have inhibited the proliferation of drones for search and rescue, environmental monitoring, and coordinated logistic operations. Accordingly, there is a need for a devices, systems, and methods for implementing a hierarchical framework of autonomous vehicles with varying capabilities and distributed intelligence. For example, such devices, systems, and methods can utilize a number of autonomous vehicles with different capabilities and roles to accomplish a user-defined objective by generating, transmitting, and executing commands based on real-time sensor data associated with the entire cluster and operating environment.

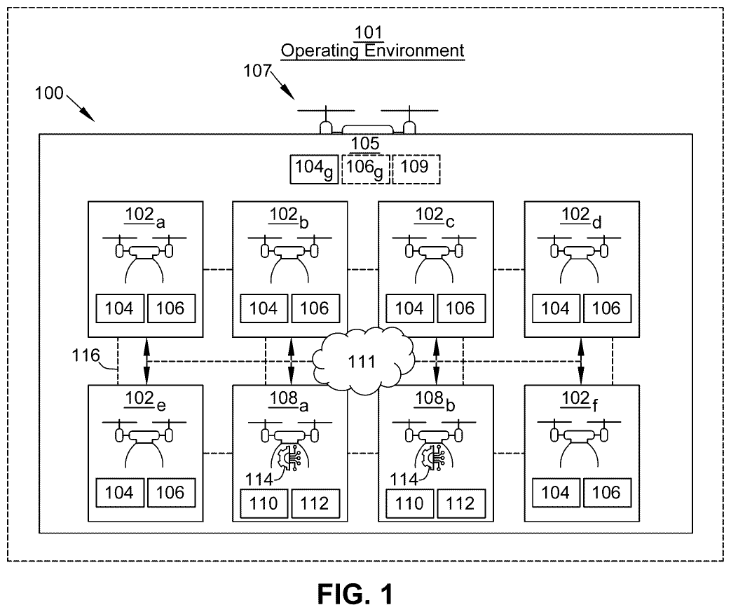

Referring now to FIG. 1, a block diagram of a system for executing a user-defined objective using a modular cluster 100 of autonomous vehicles 102_{a-f}, 108_{a,b} is depicted according to at least one non-limiting aspect of the present disclosure. According to the non-limiting aspect of FIG. 1, the cluster 100 can include a housing 105 that defines an internal cavity configured to accommodate the plurality of autonomous vehicles 102_{a-f}, 108_{a,b}. The plurality of autonomous vehicles 102_{a-f}, 108_{a,b} can include one or more Modular Micro Drone Units (“MMD”) 102_{a-f} and one or more Communication Micro Drone Unit (“CMD”) 108_{a,b}. The specific functionality of the MMDs 102_{a-f} and the CMDs 108_{a,b} will be described in further detail herein.

As used herein, the term “cluster” shall include a group of two or more autonomous vehicles specifically configured and deployed to accomplish a specific, user-defined objective. For example, a cluster can include at least one MMD 102_{a-f} and at least one CMD 108_{a,b}. The cluster 100 of FIG. 1 can include six MMDs 102_{a-f} and two CMDs 108_{a,b}. However, according to other non-limiting aspects, a cluster can include any number of MMDs 102_{a-f} and/or any number of CMDs 108ₐ, 108_{b}. A cluster, for example, may be defined by the particular objective intended to be accomplished by two or more autonomous vehicles or, alternately, by the MMDs 102_{a-f} a particular CMD 108_{a,b} is configured to communicate with, manage, and/or control. For example, if a first subset of the plurality of autonomous vehicles 102_{a-c}, 108ₐ is configured to accomplish a first objective and a second subset of the plurality of autonomous vehicles 102_{d-f}, 108_{b} is configured to accomplish a second objective, the first subset of the plurality of autonomous vehicles 102_{a-c}, 108ₐ may constitute a first cluster and the second subset of the plurality of autonomous vehicles 102_{d-f}, 108_{b} may constitute a second cluster. A first CMD 108ₐ may be configured to communicate with, manage, and/or control a first subset of MMDs 102_{a-c} and a second CMD 108_{b} may be configured to communicate with, manage, and/or control a second subset of MMDs 102_{d-f}. Thus, the first CMD 108ₐ and first subset of MMDs 102_{a-c} may constitute a first cluster and the second CMD 108 and second subset of MMDs 102_{d-f} may constitute a second cluster. The first CMD 108ₐ may be configured to communicate with the second CMD 108_{b}, even when deployed in separate clusters. In other words, one or more additional clusters can be deployed in conjunction with the cluster 100 of FIG. 1 to accomplish the user-defined objective, introducing a cluster-level modularity to the system.

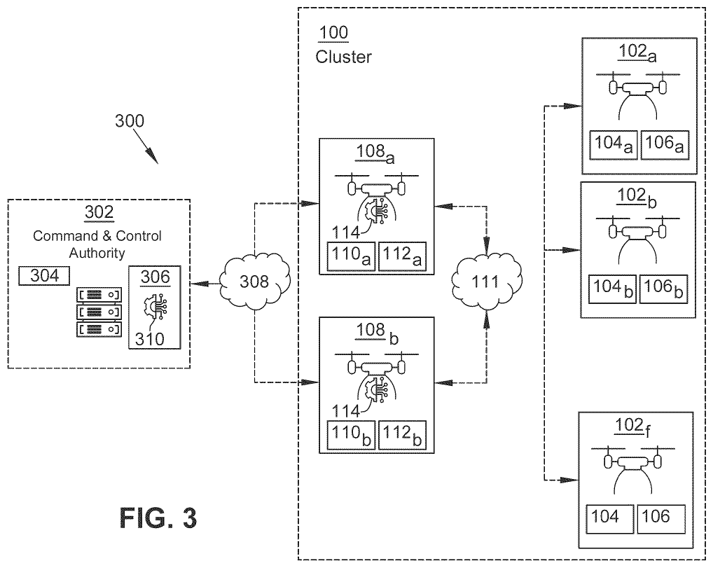

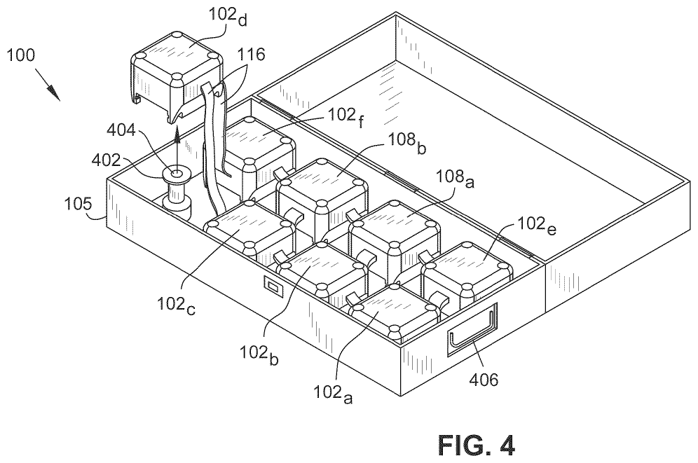

Although the housing 105 of FIG. 1 contains a single cluster 100, according to other non-limiting aspects, the housing 105 can be configured to contain two or more clusters of autonomous vehicles 102_{a-f}, 108_{a,b}. The housing 105 can be configured for manual transport from location to location throughout the operating environment 101 such as by the use of one or more handles 406 (FIG. 4) positioned on an outer surface of the housing 105. According to some non-limiting aspects, the housing 105 can include a memory 106_{g} configured to store a routing module and/or routing commands received from a remotely located computing device 302 (FIG. 3), and a control circuit 104_{g} configured to execute instructions received from the memory 106_{g} and/or the remotely located computing device (not shown). According to still other non-limiting aspects, the housing 105 can further include a propulsion system 107 configured to convey the housing 105 and the plurality of autonomous vehicles 102_{a-f}, 108_{a,b} contained therein from location to location throughout an operating environment 101 (e.g., a field, an airspace, an aquatic environment, a city, a town, a planet, space, etc.).

Still referring to FIG. 1, according to some non-limiting aspects, the housing 105 can further include a power source 109 (e.g., a battery, a capacitor, a generator, etc.) configured to power various components of the housing 105 and/or each of the plurality of autonomous vehicles 102_{a-f}, 108_{a,b} contained therein. The MMDs 102_{a-f} and CCDs 108ₐ, 108_{b} may also include their own, dedicated power sources (e.g., a battery, a capacitor, a generator, etc.), which can be electrically couplable to and configured to receive and store power from the power source 109 of the housing 105 when properly installed within the housing 105. According to some non-limiting aspects, the control circuit 104_{g} of the housing 105 can include a system-on-a-chip that includes a communications circuit configured to send and receive signals via one or more wireless protocols.

Although the housing 105 and each of the MMDs 102_{a-f} and CCDs 108ₐ, 108_{b} of FIG. 1 are exclusively configured for air-based transport, it shall be appreciated that, according to other non-limiting aspects, any of the housing 105, the MMDs 102_{a-f}, and/or the CCDs 108ₐ, 108_{b} can be alternately or additionally configured for ground-based, aquatic-based, or space-based transportation. However, as previously described, according to other non-limiting aspects, the housing 105 of the system of FIG. 1 can be alternately configured for manual transport into the operating environment 101. For example, instead of the control circuit 104_{g}, the memory 106_{g}, and/or the propulsion system 107, the housing 105 can simply include one or more handles 406 (FIG. 4).

According to still other non-limiting aspects, the housing 105 can be alternately or additionally configured for projectile-based deployments. For example, the housing 105 can be compatible with known devices configured to launch specialized projectiles of similar dimensions. Alternately, the housing 105 can be deployed from another vehicle with its own, separate propulsion system.

As depicted in FIG. 1, one or more of the plurality of autonomous vehicles 102_{a-f}, 108_{a,b} can be mechanically coupled using a plurality of connective elements 116. The connective elements 116, for example, can include break-away tethers, explosive release devices (e.g., ordinance, pyrotechnic release mechanisms, cartridge-actuated devices, propellant-actuated devices, hold-down release mechanisms, etc.), and/or non-explosive release devices (e.g., tension-based release, mechanical severing devices, electromechanical mechanisms, shape memory alloy release mechanisms, ejector release mechanisms, paraffin actuators, thermal knives, etc.), amongst others. For example, non-explosive release devices can include thermally activated release devices, such as frangibolts. The plurality of autonomous vehicles 102_{a-f}, 108_{a,b} can be arranged in a pre-configured cluster 100 based on their assigned intelligence, role, and/or payloads in order to accomplish the user-defined objective.

In further reference to FIG. 1, each autonomous vehicle of the plurality of autonomous vehicles 102_{a-f}, 108_{a,b} can include a control circuit 104 and a memory 106 configured to store instructions that, when executed by the control circuit, cause the autonomous vehicle to perform one or more of the functions and/or steps of the methods disclosed here. As depicted in FIG. 1, each autonomous vehicle of the plurality of autonomous vehicles 102_{a-f}, 108_{a,b} can be communicatively coupled to one another via a data network 111. For example, the control circuit 104 can include a system-on-a-chip that can include a communications circuit configured to send and receive signals via one or more wireless protocols. The data network 111, for example, can include a cellular network (e.g., 3G, LTE, 5G, etc.), a satellite network, a wireless infrastructure network (e.g., WiFi, WLAN, etc.), an ad hoc network (e.g., Bluetooth, NFC, Zigbee, etc.), or combinations thereof. The data network 111 may further include a private network (e.g., an intranet, etc.), a public network (e.g., the Internet, etc.), or combinations thereof.

Still referring to FIG. 1, each autonomous vehicles 102_{a-f}, 108_{a,b} of the cluster 100 can include a different payload of a plurality of interchangeable payloads. The plurality of interchangeable payloads can include, for example, camera systems (e.g., RGB, thermal, infrared, multispectral), LiDAR scanning, global positioning system (“GPS”) sensors, environmental sensors (e.g., air quality, gas detection, radiation), RFID tags and/or scanners, hyperspectral cameras, magnetometers, surveying tools (e.g., tool stations, laser scanners), ground penetrating radars, sound or acoustic sensors, communication systems, lights, lasers, or beacons, amongst other payloads that can be mixed and matched to tailor the cluster 100 to accomplish a variety of different user-defined objectives. According to some non-limiting aspects, the MMDs 102_{a-f} can include a port configured to mechanically and electrically couple the MMDs 102_{a-f} to each payload of the plurality of interchangeable payloads. Thus, it shall be appreciate that the MMDs 102_{a-f} may include a standardized mechanical and electrical configuration and the payloads can be selected based on the user-defined objective. However, according to some aspects, at least one of the MMDs 102_{a-f} can be selected from a plurality of standardized units, each of which may have a different payload that is permanently, semi-permanently, or selectively removably coupled to the MMDs 102_{a-f}.

Aside from the payloads, the MMDs 102_{a-f} can further include one or more optical sensors (e.g., pinhole cameras) integrated into their hulls in tactical positions. For example, as will be described in further detail herein, each of the MMDs 102_{a-f} can include four optical sensors configured to generate sensor/image data associated with the MMDs 102_{a-f}, the surroundings of the MMDs 102_{a-f}, and/or the operating environment 101. This image data can be transmitted to the CMDs 108ₐ, 108_{b} and/or base station and processed to generate contextual insights about the current position of the MMDs 102_{a-f}. Such insights can be utilized to alter operation of the MMDs 102_{a-f}.

Still referring to FIG. 1, each of the MMDs 102_{a-f} may be configured to communicate with each other and with each of the CMDs 108ₐ, 108_{b} via the data network 111. According to one non-limiting aspect, the data network 111 may include a short range, local, or ad hoc network (e.g., Bluetooth, encrypted radio frequencies, Zigbee, direct line of sight communications, near field communications, RFID, etc.) configured for shorter range communications. However, the CMDs 108ₐ, 108_{b} may be additionally configured to communicate with a base station via a long range, infrastructure network, such as a cellular network (e.g., 3G, LTE, 5G, etc.), a satellite network, and/or a wireless infrastructure network (e.g., WiFi, WLAN, etc.). Thus, the cluster 100 can establish a uniquely configured mesh network capable of intra-cluster and extra-cluster communications, in some instances, via the CMDs 108ₐ, 108_{b}. According to some non-limiting aspects, the cluster 100 of FIG. 1 can communicate with the CMDs 108ₐ, 108_{b} of another cluster via short range or long range network for multi-cluster operations to accomplish multiple, interrelated objectives.

Communications between the MMDs 102_{a-f} and the CMDs 108ₐ, 108_{b} of the cluster 100 of FIG. 1 may be secured to ensure confidentiality and prevent interference from third parties. For example, cryptographic protocols can be used to ensure data being transmitted between the base station and the CMDs 108ₐ, 108_{b}, the CMDs 108ₐ, 108_{b} and the MMDs 102_{a-f}, and the MMDs 102_{a-f} themselves are secure and private. For short-range networks, a communication range may generally be limited to a few hundred meters and, therefore, Advanced Encryption Standard (“AES”), Secure Socket Layer (“SSL”), and/or Virtual Private Networks (“VPNs”) may be appropriate. Alternately, a secure pairing technique requiring a passkey entry may be implanted to establish the shortrange network. For longer range networks, end-to-end encryption, VPN over cellular, AES, Public Key Infrastructure (“PKI”), and/o other means of encrypting communications at the network level may be implemented to secure communications. According to some non-limiting aspects, alternate, more secure encryption techniques may be implemented, such as AES-256, elliptic curve digital signature algorithms, elliptic curve Diffie-Hillman algorithms, type 1 encryptors, key management infrastructure, Galois/Counter Mode-AES, single channel ground and airborne radio systems, joint tactical radio systems, and/or Secure Hash Algorithm-2, may be used, amongst other techniques that comply with relevant standards (e.g., MIL-STD-810G, MIL-STD-461, etc.).

Each of the MMDs 102_{a-f} of the system 100 of FIG. 1 may include a control circuit 104_{a-f} and a memory 106_{a-f} configured to store instructions that, when executed by the control circuit 104_{a-f} cause the MMDs 102_{a-f} to perform the functionality and methods attributed to them, as disclosed herein. For example, the memory 106_{a-f} of each of the MMDs 102_{a-f} may store instructions that, when executed by the control circuit 104_{a-f} cause the MMDs 102_{a-f} to deploy from the housing 105, sever one or more connective elements 116, communicate with the CMDs 108ₐ, 108_{b} and other MMDs 102_{a-f} of the cluster 100, and/or use their respective payloads in accordance with stored instructions or received commands. According to some non-limiting aspects, the instructions stored in the memory 106_{a-f} of each of the MMDs 102_{a-f} may be provided, altered, monitored, or managed via commands transmitted by one or more of the CMDs 108ₐ, 108_{b}. Each of the CMDs 108ₐ, 108_{b} can also include a control circuit 110ₐ, 110_{b} and a memory 112ₐ, 112_{b} that stores instructions that, when executed by the control circuit 110ₐ, 110_{b} cause the MMDs 102_{a-f} to perform the functionality and methods attributed to them, as disclosed herein. However, according to some non-limiting aspects, the control circuits 110ₐ, 110_{b} and memories 112ₐ, 112_{b} used by the CMDs 108ₐ, 108_{b} may be different and more powerful than the control circuits 104_{a-f} and a memories 106_{a-f} of the MMDs 102_{a-f}. For example, the control circuits 110ₐ, 110_{b} of the CMDs 108ₐ, 108_{b} may include graphic processing units (GPUs), tensor processing units (TPUs), neural processing units (NPUs), and/or Field Programable Gate Arrays (FPGAs), amongst others. This is because instructions stored in the memories 112ₐ, 112_{b} of the CMDs 108ₐ, 108_{b} may be more resource intensive to process since the functionality attributed to the CMDs 108ₐ, 108_{b} is typically more substantial than the functionality of the MMDs 102_{a-f}. For example, the CMDs 108ₐ, 108_{b} may be responsible for communicatively coupling the cluster 100 to the base station and, therefore, may require more software and hardware capable of facilitating longer-range transmissions and more secure encryption than the MMDs 102_{a-f}.

According to some non-limiting aspects, the CMDs 108ₐ, 108_{b} of the system 100 of FIG. 1 may have more surveillance functionality and/or hardware and stronger hulls than the MMDs 102_{a-f}. For example, the CMDs 108ₐ, 108_{b} may have eight or more optical sensors configured to generate image data associated with the surroundings of the CMDs 108ₐ, 108_{b}. The control circuits 110ₐ, 110_{b} of the CMDs 108ₐ, 108_{b} (or a base station) may be further configured to process (e.g., stitch together) image data generated by the optical sensors of the CMDs 108ₐ, 108_{b} and/or MMDs 102_{a-f}, thereby providing cluster 100 level contextual insights, informing a user as to the relative position and surroundings of each of the MMDs 102_{a-f} and CMDs 108ₐ, 108_{b} of the cluster 100. Thus, it shall be appreciated that the configuration of each of the CMDs 108ₐ, 108_{b} can be specifically altered relative to the MMDs 102_{a-f} based on the size of the cluster 100, specific payloads, and user-defined objective to balance the overall weight, power, and structural requirements of the cluster 100.

According to some non-limiting aspects, the CMDs 108ₐ, 108_{b} of the cluster 100 of FIG. 1 may not have a payload, which can offset any additional weight resulting from the control circuits 110ₐ, 110_{b} and memories 112ₐ, 112_{b}, hulls, and enhanced surveillance hardware. However, according to other non-limiting aspects, one or more of the CMDs 108ₐ, 108_{b} may further include one or more of the aforementioned payloads. For example, one or more of the CMDs 108ₐ, 108_{b} may include a port configured to mechanically and electrically couple any payload from the plurality of payloads described herein. According to some non-limiting aspects, one or more of the MMDs 102_{a-f} of the cluster 100 of FIG. 1 may not have a payload and may be exclusively configured to relay signals as part of a mesh network.

The cluster 100 of FIG. 1 can operate in response to a Modular Micro Cluster Drone (“MMCD”) model 114. As depicted in FIG. 1, the MMCD model 114 can be stored in the memories 112ₐ, 112_{b} of the CMDs 108ₐ, 108_{b} and executed by the control circuits 110ₐ, 110_{b} of the CMDs 108ₐ, 108_{b}. However, according to other non-limiting aspects, the MMCD model 114 may be stored in a memory 306 (FIG. 3) and executed by a control circuit 304 (FIG. 3) of a computing device positioned in a base station or a Centralized Command Authority (“CCA”) 302 (FIG. 3). In other words, the MMDs 102_{a-f} and CMDs 108ₐ, 108_{b} may be controlled remotely via the CCA 302 (FIG. 3). In response to the MMCD model 114, the CMDs 108ₐ, 108_{b} may autonomously command the MMDs 102_{a-f} to accomplish the user-defined objective. The MMCD model 114 can be configured to establish direct communication with and between the CCA 302 (FIG. 3) and the CMDs 108ₐ, 108_{b}, which may be configured to functionₛ a localized communication link to the MMDs 102_{a-f} of the cluster 100. Prior to deployment, the CMDs 108ₐ, 108_{b} may be configured to execute an MMCD model 114 and/or integrate with a CCA 302 (FIG. 3) that hosts the MMCD model 114, thereby ensuring the MMDs 102_{a-f}, CMDs 108ₐ, 108_{b}, and/or CCA are properly configured for cluster 100 communication. According to some non-limiting aspects, the CMDs 108ₐ, 108_{b} and/or CCA 302 (FIG. 3) may be additionally configured to communicate with other clusters, which may employ a different permutation of MMDs 102_{a-f} with different payloads to accomplish different user-defined objectives, for larger scale operations.

According to some non-limiting aspects, the MMCD model 114 may include an artificial intelligence generated machine executable (“AGMX”) functionality, similar to the models disclosed in U.S. patent application Ser. No. 18/792,290, titled DEVICES, SYSTEMS, AND METHODS FOR AUTONOMOUSLY GENERATING AND IMPLEMENTING MACHINE EXECUTABLE FILES, and filed on Aug. 1, 2024, the disclosure of which is incorporated by reference in its entirety herein. Specifically, the AGMX platform 102 can include an artificial intelligence model configured to generate and transmit AGMX files that includes instructions to be executed by one or more of the CMDs 108ₐ, 108_{b} and/or MMDs 102_{a-f} of the cluster 100, subject to a risk management model. For example, a risk management model can be stored in the memory 106_{g} of the housing 105, the memory 306 (FIG. 3) of the CCA 302 (FIG. 3), or one of the memories 112ₐ, 112_{b} of a CMDs 108ₐ, 108_{b} that does not store the MMCD model 114. When executed by a corresponding control circuit, the risk management model can be configured to receive sensor feedback from the CMDs 108ₐ, 108_{b} and/or MMDs 102_{a-f} via the data network 111 and can generate and transmit monitoring commands that one or more of the CMDs 108ₐ, 108_{b} and/or MMDs 102_{a-f} of must adhere to, thereby ensuring compliant completion of the user-defined objective. Monitoring commands, for example, may be configured to alter operation of one or more of the CMDs 108ₐ, 108_{b} and/or MMDs 102_{a-f}, terminate operation of one or more of the CMDs 108ₐ, 108_{b} and/or MMDs 102_{a-f}, alter a path of traversal of one or more of the CMDs 108ₐ, 108_{b} and/or MMDs 102_{a-f}, and/or partially disable functionality (e.g., of a sensor or payload, of a propulsion system, etc.)) of one or more of the CMDs 108ₐ, 108_{b} and/or MMDs 102_{a-f}, amongst other monitoring commands. The risk management model can be a module separate from the MMCD model 114 or stored and executed by a separate computing device (e.g., the CCA and/or the control circuit 104_{g} and memory 106_{g} of the housing 105, assuming one or more CMDs 108ₐ, 108_{b} store and execute the MMCD model 114) to ensure the risk management model runs without bias from the MMCD model 114.

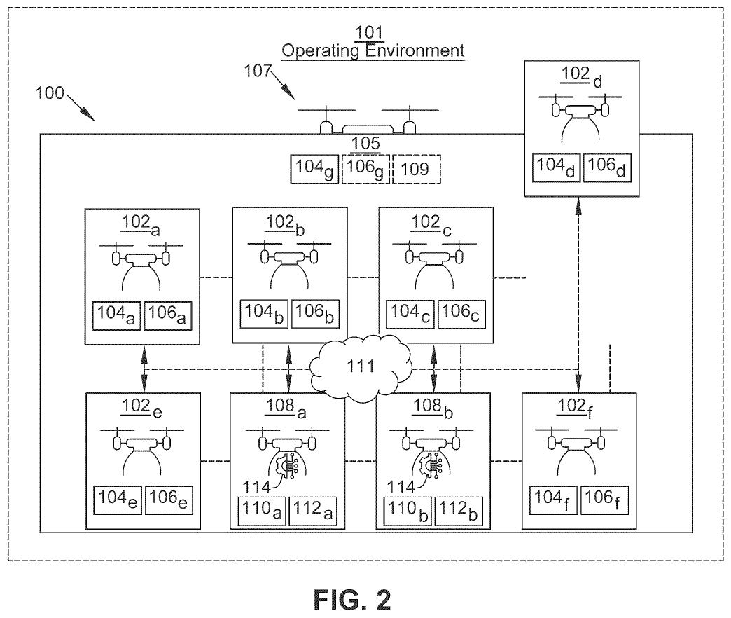

Referring now to FIG. 2, another block diagram of the system of FIG. 1 is depicted, wherein an MMD 102_{d} of the plurality of MMDs 102_{a-f} has been deployed from the cluster 100 into the operating environment 101. According to the non-limiting aspect of FIG. 2, the fourth MMD 102_{d} has been deployed from the housing 105 into the operating environment 101. As will be described in further detail herein, the housing can include a deployment mechanism configured to deploy each of the CMDs 108ₐ, 108_{b} and MMDs 102_{a-f} either individually at different times or collectively at the same time.

In further reference to FIG. 2, the connective elements 106 that, as depicted in FIG. 1, previously mechanically coupled the fourth MMD 102_{d} to the third MMD 102_{c} and fifth MMD 102ₑ has been separated, which mechanically releases the fourth MMD 102_{d} from the third MMD 102_{c} and the fifth MMD 102ₑ. If the connective elements 106 included break-away tethers, such tethers have been severed. If the connective elements 106 included explosive or non-explosive release devices, such releases devices have been activated. According to some non-limiting aspects, separation of one or more of the connective elements 106 can be performed in coordination with activation of the deployment mechanism. Separation of the connective elements 106 and/or activation of the deployment mechanism can be initiated via the control circuit 104_{g} of the housing 105, the control circuits 110ₐ, 110_{b} of the CMDs 108ₐ, 108_{b}, or a control circuit 304 (FIG. 3) of the CCA 302 (FIG. 3) depending on the specific configuration of the cluster 100 employed by the user. Regardless, FIG. 2 further depicts how the fourth MMD 102_{d} remains communicatively coupled to the CMDs 108ₐ, 108_{b} and, therefore, the other MMDs 102_{a-c,e-f}. According to the non-limiting aspect wherein the housing 105 includes a central power source 109, upon deployment, the fourth MMD 102_{d} has been decoupled from the central power source 109 of the housing 105 and is being powered by its own, dedicated power source (e.g., a battery, a capacitor, a generator, etc.) (not shown).

Referring now to FIG. 3, a bock diagram of several potential configurations of the cluster 100 of FIG. 1 is depicted according to at least one non-limiting aspect of the present disclosure. According to the non-limiting aspect of FIG. 3, the cluster 100 (FIG. 1) can be configured such that the CCA 302 is communicatively coupled to the CMDs 108ₐ, 108_{b} via a long range network 308, such as a cellular network (e.g., 3G, LTE, 5G, etc.), a satellite network, and/or a wireless infrastructure data network (e.g., WiFi, WLAN, etc.). The CMDs 108ₐ, 108_{b}, however, can be communicatively coupled to the MMDs 102_{a-f} via a local, short range data network 111 (e.g., Bluetooth, encrypted radio frequencies, Zigbee, direct line of sight communications, etc.). Collectively, the CMDs 108ₐ, 108_{b} nd MMDs 102_{a-f} establish a mesh network.

Still referring to FIG. 3, according to one non-limiting aspects, the MMCD model 114 can be stored in the memories 112ₐ, 112_{b} of the CMDs 108ₐ, 108_{b} and executed by the control circuits 110ₐ, 110_{b} of the CMDs 108ₐ, 108_{b}. In other words, according to the non-limiting aspect of FIG. 3, the CMDs 108ₐ, 108_{b} can be configured to generate commands that either control the MMDs 102_{a-f} and/or are executable by each of the MMDs 102_{a-f} for autonomous control. In other words, the CMDs 108ₐ, 108_{b} of the can be configured to control the cluster 100 via the short range data network 111. In such a configuration, the CMDs 108ₐ, 108_{b} can transmit data (e.g., surveillance data generated by the CMDs 108ₐ, 108_{b}, telemetry, image data, sensor data, etc.) back to the CCA 302 for review and/or processing via the long range 308 data network. However, according to other non-limiting aspects, the MMCD model 114 may be stored in a memory 306 and executed by a control circuit 304 of a computing device positioned in a base station or a CCA 302. In other words, the MMDs 102_{a-f} and CMDs 108ₐ, 108_{b} may be controlled remotely via the CCA 302.

According to some non-limiting aspects, it may be preferable for the configuration 300 of FIG. 3 to initially use two or more CMDs 108ₐ, 108_{b} to store and execute the MMCD model 114 in case one of the CMDs 108ₐ, 108_{b} experiences a technical difficulty or is otherwise incapacitated. Accordingly, control of the cluster 100 can be maintained during unforeseen circumstances. According to some non-limiting aspects, a CCA model 310 may be stored in a memory 306 and executed by a control circuit 304 of a computing device of the CCA 302. The CCA model 310 can be configured to function as one of the CMDs 108ₐ, 108_{b} the MMCD model 114 via the long range network 308. In other words, the CCA model 310 may be configured to function as a contingency to the MMCD model 114, when the configuration 300 primarily relies on the CMDs 108ₐ, 108_{b} to store and execute the MMCD model 114. For example, if the CCA model 310 has not received expected data (e.g., a status signal, telemetry, image data, sensor data, etc.) from the CMDs 108ₐ, 108_{b} within a predefined interval (e.g., one minute, five minutes, ten minutes, etc.) the CCA model 310 may be configured to function as the MMCD model 114 and control the cluster 100.

Alternately or additionally, the configuration 300 of FIG. 3 can utilize the CCA model 310 as a risk management model, configured to receive sensor feedback from the CMDs 108ₐ, 108_{b} and/or MMDs 102_{a-f} via the long range data network 308 and generate and transmit monitoring commands that one or more of the CMDs 108ₐ, 108_{b} and/or MMDs 102_{a-f} of must adhere to, thereby ensuring compliant completion of the user-defined objective. For example, the CCA model 310 can include a risk management model similar to those disclosed in U.S. patent application Ser. No. 18/792,290, titled DEVICES, SYSTEMS, AND METHODS FOR AUTONOMOUSLY GENERATING AND IMPLEMENTING MACHINE EXECUTABLE FILES, and filed on Aug. 1, 2024, the disclosure of which is incorporated by reference in its entirety herein. Such a configuration can ensure that compliance of the CMDs 108ₐ, 108_{b} and/or MMDs 102_{a-f} Of the cluster 100 is be managed in an unbiased manner.

According to other non-limiting aspects, the configuration 300 of FIG. 3 can be configured to initially utilize the CCA model 310 stored in the memory 306 and executed by the control circuit 304 of the computing device associated with the CCA 302 as the MMCD model 114. The CCA model 310 can be initially configured to generate commands that either control the CMDs 108ₐ, 108_{b} and MMDs 102_{a-f} and/or are executable by each of the CMDs 108ₐ, 108_{b} and MMDs 102_{a-f} for autonomous control. In other words, the CCA model 310 can be configured to control the cluster 100 via the long range data network 308. Accordingly, the MMCD model 114 of the CMDs 108ₐ, 108_{b}, therefore, can be configured to receive commands from the CCA model 310 via the long range data network 308 and, if authorized by the CCA model 310, attenuate the commands based on sensor data (e.g., surveillance data generated by the CMDs 108ₐ and/or 108_{b}, data received from the MMDs 102_{a-f}, data or instructions received from the CCA, etc.). Thus, the MMCD model 114 may cause the CMDs 108ₐ, 108_{b} to distribute such commands to the MMDs 102_{a-f} via the short range data network 111. In other words, commands can be updated in real-time based on activity and/or conditions of the cluster 100 and/or operating environment 101 (FIGS. 1 and 2). This can enhance responsiveness and ensure the user-defined objective is accomplished.

According to some non-limiting aspects, the MMCD models 114 may be configured to function as a contingency to the CCA model 310, when the configuration 300 primarily relies on the CCA 302 to store and execute the CCA model 310. According to such aspects, a first CMD 108ₐ may be configured to receive, attenuate and transmit commands from the CCA 302 to the MMDs 102_{a-f} and a second CMD 108_{b} may be configured to store and execute a risk management model to ensure compliance of the first CMD 108ₐ and/or MMDs 102_{a-f} on behalf of the CCA model 310.

Referring now to FIG. 4, a perspective view of the cluster 100 of FIG. 1 is depicted according to at least one non-limiting aspect of the present disclosure. According to the non-limiting aspect of FIG. 4, the housing 105 can include deployment mechanisms 402 configured to deploy each of the CMDs 108ₐ, 108_{b} and MMDs 102_{a-f}. Although a single deployment mechanism 402 corresponding to the fourth MMD 102_{d} is depicted in FIG. 4, it shall be appreciated that the housing 105 includes similar deployment mechanisms 402 positioned beneath each of the CMDs 108ₐ, 108_{b} and MMDs 102_{a-f} such that all of the CMDs 108ₐ, 108_{b} and MMDs 102_{a-f} can be deployed from the housing 105 upon manual activation or receipt of a signal from the housing 105, the CMDs 108ₐ, 108_{b}, or the CCA 302 (FIG. 3). The deployment mechanisms 402 of the housing 105 can be configured either for individual or collective activation. For example, according to some non-limiting aspects, all of the deployment mechanisms 402 can be simultaneously activated such that all of the CMDs 108ₐ, 108_{b} and MMDs 102_{a-f} are deployed at once. However, according to other non-limiting aspects, one or more of the deployment mechanisms 402 can be sequentially activated such that one or more of the corresponding CMDs 108ₐ, 108_{b} and MMDs 102_{a-f} are deployed in accordance with a predefined sequence.

In further reference to FIG. 4, each of the deployment mechanisms 402 may have an interface 404. For example, the interface 404 may be configured to mechanically and/or electrically couple the CMDs 108ₐ, 108_{b} and MMDs 102_{a-f} to the housing 105 prior to deployment. For example, the interface 404 can ensure that the CMDs 108ₐ, 108_{b} and MMDs 102_{a-f} are secured within the housing 105 and protected from undesirable contact during transport prior to deployment. According to some non-limiting aspects, the CMDs 108ₐ, 108_{b} and MMDs 102_{a-f} can receive electrical signals via the interface 404, such as power from the power source 109 (FIG. 1) of the housing or signals (e.g., programming, commands, firmware updates, etc.) from the housing 105, the CMDs 108ₐ, 108_{b}, or the CCA 302 (FIG. 3) prior to deployment. Although the housing 105 of FIG. 4 is configured to accommodate a total of eight CMDs 108ₐ, 108_{b} and MMDs 102_{a-f}, according to other non-limiting aspects, the housing 105 can be alternately configured to accommodate any number of CMDs 108ₐ, 108_{b} and MMDs 102_{a-f}. Additionally, portions of the housing 105 can include a cushioned material, a heat resistant material, a thermally resistant material, a floating material, and/or a radiation hardened material amongst others.

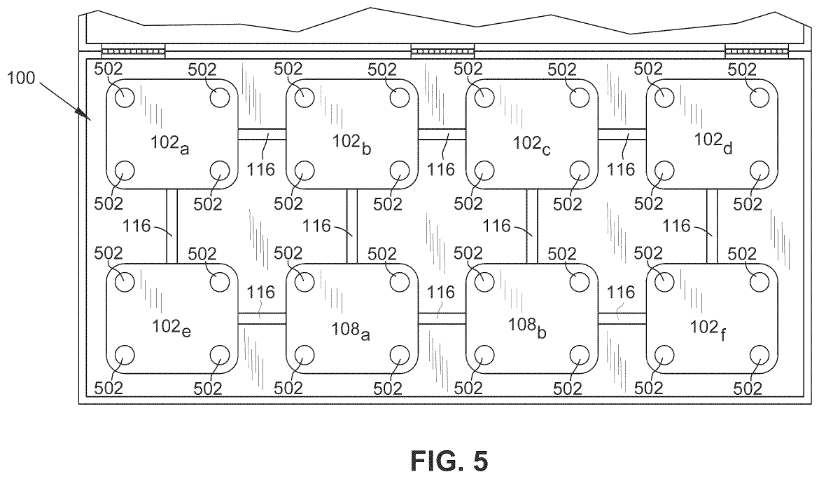

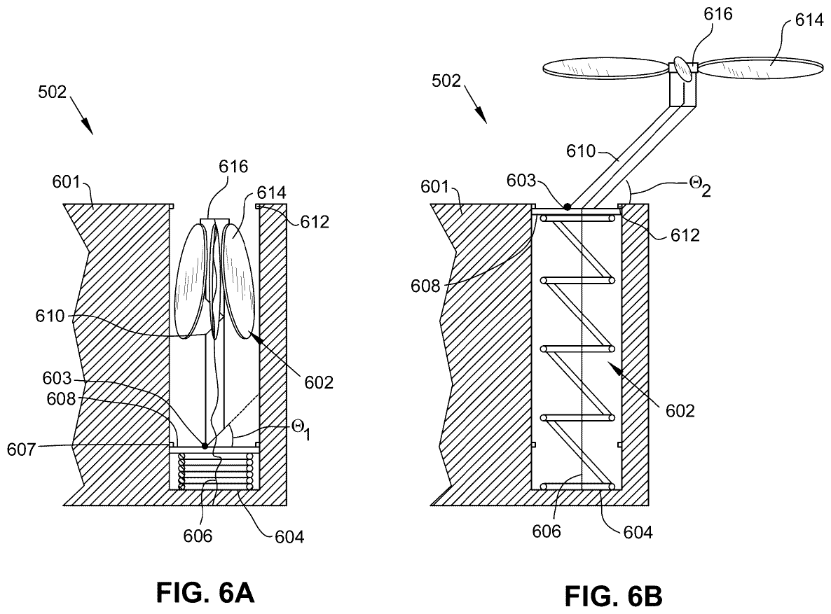

Referring now to FIG. 5, a top view of the cluster 100 of FIG. 1 is depicted according to at least one non-limiting aspect of the present disclosure. According to the non-limiting aspect of FIG. 5, each of the CMDs 108ₐ, 108_{b} and MMDs 102_{a-f} can include at least one propulsion system 502. For example, each of the CMDs 108ₐ, 108_{b} and MMDs 102_{a-f} can include four propulsion systems 502 each of which can positioned in a corner of the CMDs 108ₐ, 108_{b} and MMDs 102_{a-f}. It shall be appreciated that such a configuration can be used to distribute the weight of each of the CMDs 108ₐ, 108_{b} and MMDs 102_{a-f} across each of the propulsion systems 502. However, according to other non-limiting aspects, at least one of the CMDs 108ₐ, 108_{b} or MMDs 102_{a-f} can have as little as one propulsion system 502 configured to sustain the weight of its respective CMD 108ₐ, 108_{b} or MMD 102_{a-f}. As will be described in further detail with reference to FIGS. 6A and 6B, the propulsion systems 502 are stowed because, according to FIG. 5, none of the CMDs 108ₐ, 108_{b} or MMDs 102_{a-f} have been deployed from the housing 105. Likewise, according to FIG. 5, the connective elements 116 are depicted intact. However, upon deployment, each connective element 116 mechanically coupling the CMDs 108ₐ, 108_{b} and MMDs 102_{a-f} of the cluster 100 will be severed, allowing each of the CMDs 108ₐ, 108_{b} and MMDs 102_{a-f} of the cluster 100 to traverse an operating environment 101 (FIG. 1) independent of one another via the propulsion systems 502.

Referring now to FIGS. 6A and 6B, sectioned side views of any of the CMDs 108ₐ, 108_{b} or MMDs 102_{a-f} (FIGS. 1-5) of the cluster 100 of FIG. 1 (FIGS. 1-5) are depicted according to at least one non-limiting aspect of the present disclosure. Specifically, FIG. 6A depicts a propulsion system 502 of the CMDs 108ₐ, 108_{b} and MMDs 102_{a-f} (FIGS. 1-5) in a stowed condition and FIG. 6B depicts the propulsion system 502 of the CMDs 108ₐ, 108_{b} and MMDs 102_{a-f} (FIGS. 1-5) in an activated condition. Although the propulsion system 502 of FIGS. 6A and 6B is specifically configured for air-based travel, it shall be appreciated that, according to other non-limiting aspects, the propulsion system 502 can be alternately configured for water-based, space-based, or ground-based travel.

In further reference to FIG. 6A, a body 601 of the CMDs 108ₐ, 108_{b} and MMDs 102_{a-f} (FIGS. 1-5) can define an internal cavity 602 configured to accommodate a spring member 604 and a propeller 614. The spring member 604 can transition between a stressed condition, as depicted in FIG. 6A and a biased or extended position, as depicted in FIG. 6B. The propeller 614 can be mechanically coupled to a motor 616 at the end of a shaft 610, which can be mechanically coupled to a base member 608 via a hinge 603. The base member 608 can provide a solid surface configured to compress the spring member 604 into a stressed condition when the propeller 614 is properly stowed within the internal cavity 602. The base member 608, for example, can prevent the spring member 604 from transitioning from the stressed condition to the biased or extended position by one or more blocking members 607. The one or more blocking members 607 can be retracted upon deployment, allowing the base member 608 to pass such that the spring member 604 can transition to the biased or extended position as depicted in FIG. 6B. In the biased or extended position, the base member 608 can be blocked by one or more gates 612. Additionally, the blades of the propeller 614 can be biased by a spring in the extended position. However, when stowed within the internal cavity 602, the blades of the propeller 614 may be compressed towards the shaft 610. Upon activation, the spring bias may cause the blades of the propeller 614 to return to the extended position for rotation via the motor 616. Additionally, a cable 606 can be mechanically coupled to a base of the body 601 of the CMDs 108ₐ, 108_{b} and MMDs 102_{a-f} (FIGS. 1-5), traversing through a hole defined by the spring member 604 and through a hollow cavity of the shaft 610. Notably, a bottom surface of the shaft 610 defines a first angle θ₁ relative to the substantially flat top surface of the base member 608. The cable 606 can be mechanically coupled to motor 616 at the end of a shaft 610. As depicted in FIG. 6A, when the propulsion system 502 is stowed and the spring member 604 is in the stressed condition and retained by the one or more blocking members 607, the cable 606 has slack.

However, referring to FIG. 6B, the propulsion system 502 of the CMDs 108ₐ, 108_{b} and MMDs 102_{a-f} (FIGS. 1-5) has been activated. The one or more blocking members 607 have been retracted, which has allowed the spring member 604 to return to its biased condition, pushing the base member 608 to the top of the internal cavity 602 defined by the body 601 of the CMDs 108ₐ, 108_{b} and MMDs 102_{a-f} (FIGS. 1-5), where it is blocked by the one or more gates 612, which ensures proper positioning of the shaft 610, propeller 614, and motor 616. However, according to other non-limiting aspects, other blocking members can be included within the internal cavity 602 to ensure proper positioning of the shaft 610, propeller 614, and motor 616.

Still referring to FIG. 6B, as the spring member 604 pushes the base member 608 to the top of the internal cavity 602, the cable 606 remains anchored to the base of the body 601. Accordingly, as the propulsion system 502 is activated, the motor 616 pulls the cable 606 up, eliminating the slack depicted in FIG. 6A. In FIG. 6B, it is evident that a tension has been created within the cable 606 between the motor 616 and the base of the body 61, which causes the shaft down 610 to pivot about the hinge 603 until a bottom surface of the shaft 610 is flush with the substantially flat top surface of the base member 608. Thus, in the activated condition, the cable 606 causes the shaft 610 itself to define a second angle θ₂ relative to the substantially flat top surface of the base member 608. According to some non-limiting aspects, the first angle θ₁ is the same as the second angle θ₂. In this way, an angled propulsion system 502 can be compactly and discretely stowed within the CMDs 108ₐ, 108_{b} and MMDs 102_{a-f} (FIGS. 1-5) until deployed from the housing 105 (FIGS. 1-5). According to some non-limiting aspects, a similar hinge and angle configuration can be deployed on the shaft 610 just below the motor 616 to ensure proper positioning of the propellers upon activation (e.g., sufficiently parallel to a top surface of the CMDs 108ₐ, 108_{b} and MMDs 102_{a-f} (FIGS. 1-5).

According to some non-limiting aspects, the cable 606 can be further configured as an electrical conduit providing electrical power from a power source of the CMDs 108ₐ, 108_{b} and MMDs 102_{a-f} (FIGS. 1-5) to the motor 616. Thus, once deployed, the propulsion system 502 can rotate the propeller 614 via electrical power provided to the motor 616, thereby propelling the CMDs 108ₐ, 108_{b} and MMDs 102_{a-f} (FIGS. 1-5) through the operating environment 101 (FIGS. 1 and 2). According to some non-limiting aspects, the motor 616 can include an actuator configured to further angle the propeller 614 for additional steering, precision, and control of the CMDs 108ₐ, 108_{b} and MMDs 102_{a-f} (FIGS. 1-5).

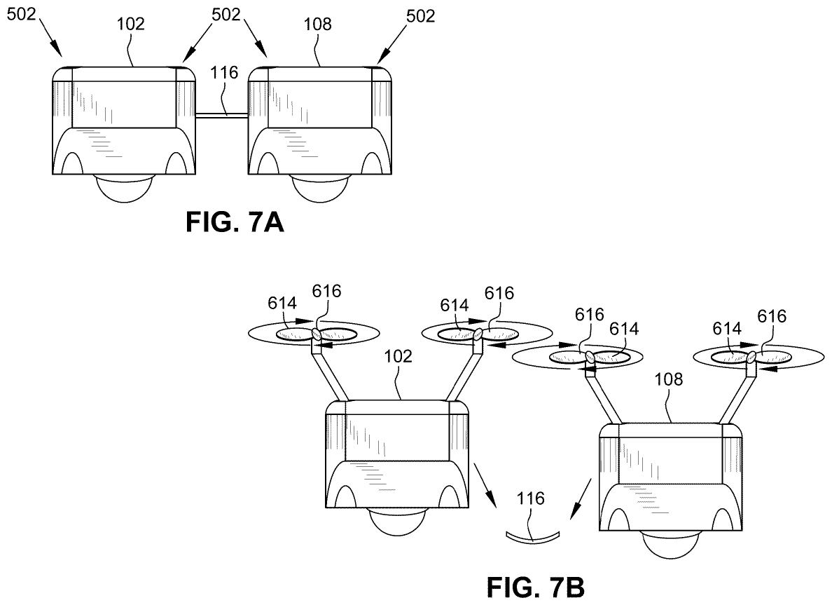

Referring now to FIGS. 7A and 7B, side views of a CMD 108 and an MMD 102 of the cluster 100 of FIG. 1 (FIGS. 1-5) before and after deployment are depicted according to at least one non-limiting aspect of the present disclosure. For example, FIG. 7A depicts the CMD 108 and the MMD 102 prior to deployment. Accordingly, the propulsion systems 502 of both of the CMD 108 and the MMD 102 are stowed and the CMD 108 is mechanically coupled to the MMD 102 via the connective element 116, which remains intact. However, according to FIG. 7B, both of the CMD 108 and the MMD 102 have been deployed and, therefore, the propulsion systems 502 have been activated. Thus, the shaft 610, the propeller 614, and the motor 616 are outside of the body of the CMD 108 and the MMD 102, with the shafts 610 of the propulsion system 502 properly positioned at the second angle θ₂ (FIGS. 6A and 6B). According to FIG. 7B, the propellers 614 are rotating via electrical power provided to the motor 616.

In further reference to FIG. 7B, the connective element 116 between the CMD 108 and the MMD 102. According to the non-limiting aspect wherein the connective element 116 includes a break-away tether, the tether has broken. According to the non-limiting aspect wherein the connective element 116 includes an explosive release device, the release devices has been detonated. According to the non-limiting aspect wherein the connective element 116 includes a non-explosive release devices mechanical, thermal, or electrical energy has caused the connective element 116 to release from the CMD 108 and the MMD 102. Accordingly, the CMD 108 and the MMD 102 are free to traverse the operating environment 101 (FIGS. 1 and 2) and perform their respective tasks relative to the user-defined objective.

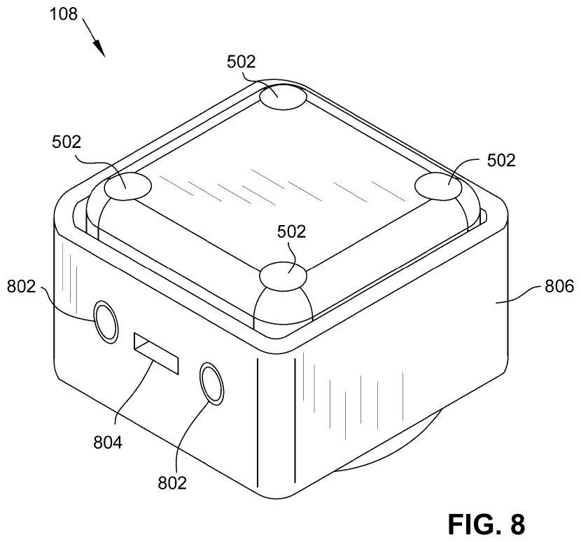

Referring now to FIG. 8, a perspective view of a CMD 108 of the cluster 100 of FIG. 1 is depicted according to at least one non-limiting aspect of the present disclosure. As previously discussed, the CMD 108 can include one or more propulsion systems 502. However, according to the non-limiting aspect of FIG. 8, the CMD 108 can include a specialized hull 806. For example, the hull 806 can be signal resistant and/or armored hull. In other words, the hull 806 can be include a material configured to reduce, block, or control electromagnetic signals. This can protect the CMD 108 from external interference or prevent its own signals from being detected or intercepted by an unauthorized third party. For example, the hull 806 can be produced from a metal composite, a carbon fiber composite, and/or a radar-absorbent materials. The hull 806 may further include a conductive coating or special mesh that can protect the CMD 108 from jamming, spoof attacks, or electromagnetic pulses. Alternately or additionally, the hull 806 can include a radiation hardened material to resist damage or prevent malfunctions caused by radiation. This can protect internal electronics from bit flipping, damaged transistors, or induced currents that can adversely effect operation of the CMD 108 and, therefore, the cluster 100 (FIGS. 1-5). According to some non-limiting aspects, the hull 806 can include a material configured to protect the CMD 108 from external perturbations, such as a kevlar, carbon fiber, ceramic, and/or an ablative material, amongst others. According to other non-limiting aspects, the hull 806 can include a multi-layer insulation and/or a reflective surface configured to shield the CMD 108 from visible and/or infrared detection.

Still referring to FIG. 8, the CMD 108 can further include one or more image sensors 802 for wide-angle imaging, such as a pinhole camera, a fisheye camera, or ultra-wide-angle optics. These sensors 802 can be low profile and may utilize a hard-to-detect form factor. Each image sensor 802 may be configured for a one-hundred-and-eighty degree field of view and, therefore, using two or more of such sensors 802 can enable the CMD 108 to have a three-hundred and sixty collective field-of-view for enhanced surveillance and situational awareness. According to some non-limiting aspects, image data generated by each of the image sensors 802 can be stitched together (e.g., via a control circuit of the CMD 108 or the CCA 302 (FIG. 3)) to create a composite view that covers a much larger area than a single image sensor 802. Such composite views of the cluster 100 (FIGS. 1-5) can be broadcast to the CCA 302 (FIG. 3). This can be particularly helpful in monitoring operation of other autonomous vehicles of the cluster 100 (FIGS. 1-5). For example, according to one non-limiting aspect, the image sensors 802 can be arranged (e.g., positioned on opposing sides of the CMD 802) to enable the CMD 108 to operate with full “spherical” awareness. This means the CMD 108 can perceive and monitor its entire surroundings in all directions, three-hundred-and-sixty degrees horizontally and one-hundred-and-eighty degrees vertically, forming a complete sphere of sensory coverage around the CMD 108. In other words, the CMD 108 can be outfitted with image sensors 802 specifically configured and arranged to enable the CMD 108 to generate sufficient image data, which it can use to generate a comprehensive characterization of the cluster 100 (FIGS. 1-5) and operating environment 101 (FIGS. 1 and 2), as necessary to execute the user-defined objective.

According to FIG. 8, the CMD 108 can further include one or more anchors 804 configured for mechanical engagement with the connective elements 116 (FIGS. 1, 2, 4, 5, 7A, and 7B). For example, the connective tether can be threaded through and secured to the one or more anchors 804 of the CMD 108. For example, the one or more anchors 804 can be dimensionally configured such that a blocking member (e.g., a head, a knot) of each connective elements 116 (FIGS. 1, 2, 4, 5, 7A, and 7B) cannot traverse through the one or more anchors 804. However, the connective elements 116 (FIGS. 1, 2, 4, 5, 7A, and 7B) can be constructed from a material that has a tensile strength that fails in response to tensions created by the CMD 108 upon activation of the propulsion systems 502. Accordingly, when the propulsion systems 502 are activated, the connective elements 116 (FIGS. 1, 2, 4, 5, 7A, and 7B) are severed and the CMD 108 can traverse the operating environment 101 (FIGS. 1 and 2) independent of the other autonomous vehicles of the cluster 100 (FIGS. 1-5).

According to other non-limiting aspects, the one or more anchors 804 of the CMD 108 of FIG. 8 can include a release mechanism, a portion of which may be contained within the hull 806 of the CMD 108. The connective elements 116 (FIGS. 1, 2, 4, 5, 7A, and 7B) may include a blocking member and the one or more anchors 804 can define a cavity configured to receive the blocking member when the blocking member is in a first orientation relative to the one or more anchors 804. However, the cavity of the anchor 804 may not be able to receive the blocking member when the blocking member is in a second orientation relative to the one or more anchors 804. Accordingly, the one or more anchors 804 can be configured to selectively prevent the connective element (FIGS. 1, 2, 4, 5, 7A, and 7B) from traversing through its cavity in the second orientation, such that the one or more anchors 804 retain the connective element (FIGS. 1, 2, 4, 5, 7A, and 7B). The release mechanism of the one or more anchors 804 can be configured to move the blocking member from the second orientation to the first orientation such that the connective element (FIGS. 1, 2, 4, 5, 7A, and 7B) can traverse through the anchor 804 and, therefore, can be released from the one or more anchors 804. Alternately, the release mechanism may be configured to completely remove or sever the blocking member from the connective element (FIGS. 1, 2, 4, 5, 7A, and 7B) such that the connective element (FIGS. 1, 2, 4, 5, 7A, and 7B) can traverse through the one or more anchors 804. The internal release member may be configured to utilize ordinance, a mechanism (e.g., a spring lock, a magnetic lock, etc.), an actuator (e.g., a servo-actuated pin or gate, etc.), and/or thermal energy (e.g., a burn wire, a heater, a laser, etc.) to release the connective element (FIGS. 1, 2, 4, 5, 7A, and 7B) from the anchor 804.

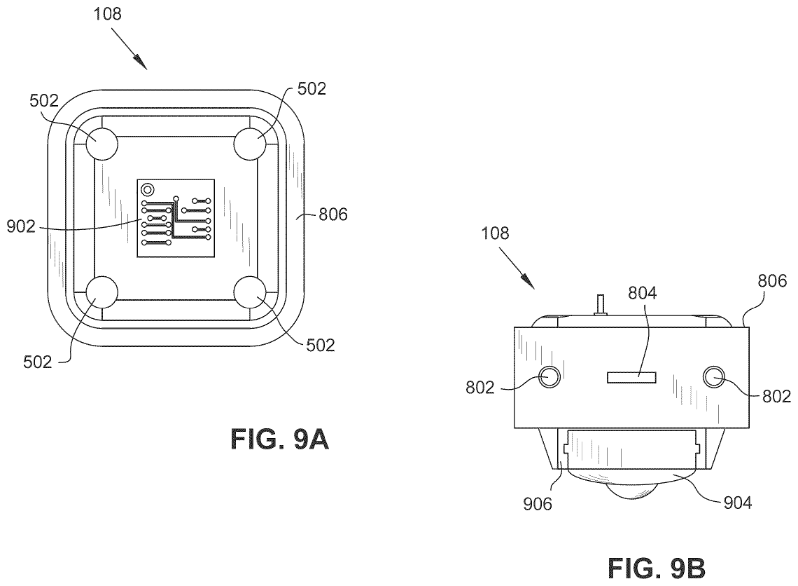

Referring now to FIGS. 9A and 9B, a top and side view of the CMD 108 of FIG. 8 are depicted according to at least one non-limiting aspect of the present disclosure. According to FIG. 9A, the CMD 108 can further include a communications circuit 902. The communications circuit 902 of the CMD 108 can be configured to facilitate not only intra-cluster 100 communications via the short range data network 111 (FIGS. 1-3) but also inter-cluster 100 communications or communications with the CCA 302 (FIG. 3) via the long range data network 308 (FIG. 3). Accordingly, it shall be appreciated that, relative to the MMDs 102_{a-f}, the communications circuit 902 of the CMD 108 can include increased capabilities. For example, the communications circuit 902 may be configured for multi-band or, at least, dual-band communications to facilitate the communications required of the CMD 108. The communications circuit 902 can be configured to switch between different communications layers and/or simultaneously transmit and receive signals via the different communications layers, depending on operational needs. The communications circuit 902 may include multiple receiver modules, at least one for short range communications and one for long range communications, a shared processing unit for protocol switching, data routing, encryption, and bandwidth prioritization and management, an antenna system (e.g., dipole antennas, 5 GHz, 2.4 GHz, L-band, S-band, Ka-band, etc.), and a power management circuit. The power management circuit may be configured to balance the very high power requirements of the long-range communications and the lower power requirements of the short-range communications.

In reference to FIG. 9B, the CMD 108 can further include a surveillance module 904. The surveillance module 904 can be configured for tactical reconnaissance, search-and-rescue, and/or target tracking on behalf of the cluster 100 (FIGS. 1-5). For example, the surveillance module 904 can include an infrared camera configured to detect heat-generating targets during night operations and/or adverse weather conditions. Accordingly, mage data generated by the surveillance module 904 can complement image data generated by the image sensors 802 (FIG. 8). However, according to other non-limiting aspects, the surveillance module 904 can include visible light and/or electro-optical cameras with higher zooms (e.g., thirty to sixty times), low-light sensors, global shutters, multi-spectral sensors, hyperspectral sensors, LiDAR modules, RADAR or synthetic aperture RADAR, acoustic or RF sensors, and/or optical zoom or ISR payload pods, amongst others). The surveillance module 904 can be configured for modular integration into the CMD 108 via a port 906 configured to electrically and mechanically couple the surveillance module 904 to the CMD 108. The surveillance module 904, therefore, may be one of a plurality of different payloads (e.g., visible light and/or electro-optical cameras with higher zooms (e.g., thirty to sixty times), low-light sensors, global shutters, multi-spectral sensors, hyperspectral sensors, LiDAR modules, RADAR or synthetic aperture RADAR, acoustic or RF sensors, optical zoom or ISR payload pods, etc.) configured for use with the CMD 108 and selected based on relevance to the user-defined objective. The port 906, therefore, can be universally configured to electrically and mechanically couple each of the plurality of different payloads to the CMD 108. However, according to some non-limiting aspects, the surveillance module 904 can be an integral or semi-permanent (welded, fastened, etc.) component of the CMD 108. It shall be appreciated that, due to the enhanced hull 806 and more capable communications circuit 902, the propulsion systems 502 of the CMD 108 may be more powerful (e.g., stronger motors, larger propellers, etc.) than the propulsion systems 502 of the MMDs 102_{a-f}.

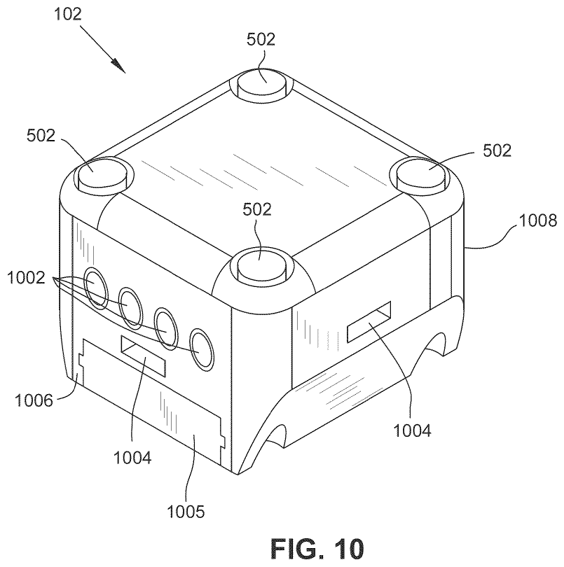

Referring now to FIG. 10, a perspective view of an MMD 102 of the cluster 100 of FIG. 1 is depicted according to at least one non-limiting aspect of the present disclosure. According to the non-limiting aspect of FIG. 10, the MMD 102 can include two or more propulsion systems 502 and one or more image sensors 1002, which can be tactically positioned to generate image data that enables functionality of the specific MMD 102. Although the image sensors 1002 of the MMD 102 may be the same types of sensors described in reference to the image sensors 802 (FIG. 8) of the CMD 108 (FIG. 8), they may be arranged and implemented to provide perspectives relevant to a specific task assigned to the MMD 102. For example, two or more image sensors 1002 may be positioned on a single side of the MMD 102 to provide a field of view that sufficiently encompasses operational field employed by a payload 1104 employed by the MMD 102. As depicted in FIG. 10, a hull 1008 of the MMD 102 may be less resilient or armored that the hull 806 (FIG. 8) of the CMD 108 (FIG. 8). However, similar to the port 906 (FIG. 9B) of the CMD 108 (FIG. 9B), the hull 1008 of the MMD 102 may define a port 1006 configured to electrically and mechanically couple the payload 1104 to the hull 1008 of the MMD 102. The MMD 102 may have one or more anchors 1004 configured similar to the anchors 804 (FIG. 8) of the CMD 108 (FIG. 8).

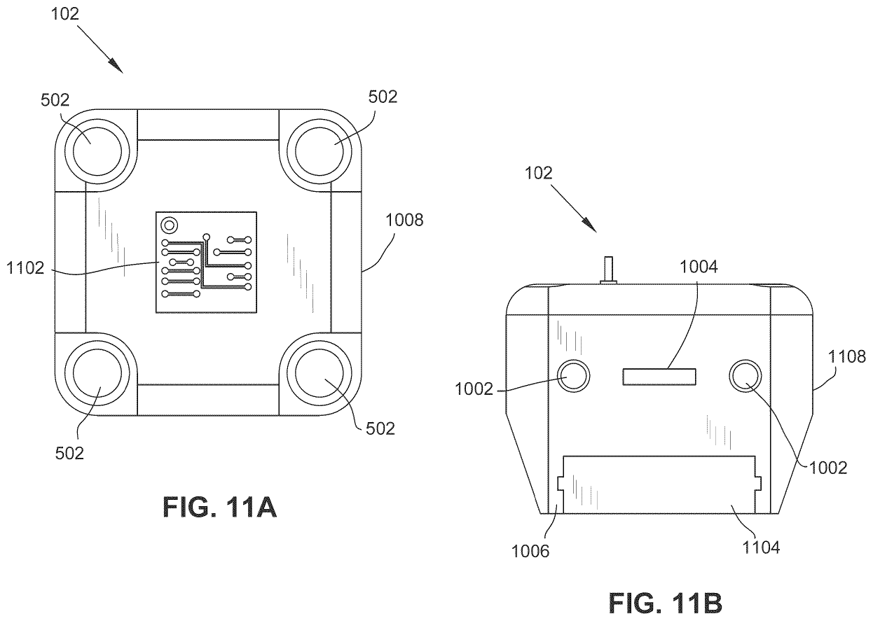

The aforementioned features of the MMD 102 are further illustrated in FIGS. 11A and 11B, which respectively depict a top and side view of the MMD 102 according to at least one non-limiting aspect of the present disclosure. However, as illustrated in FIG. 11A and B, the MMD 102 can also include a communication circuit 1102. However, the communication circuit 1102 of the MMD 102 may only be configured for intra-cluster 100 (FIGS. 1-5) communications and, therefore, may only be configured to communicate via single-band (e.g., 2.4 GHz, 5.8 GHz, etc.) communications. In other words, the communication circuit 1102 of the MMD 102 facilitates communications via the short range data network 111 (e.g., Bluetooth, encrypted radio frequencies, Zigbee, direct line of sight communications, etc.). According to one non-limiting aspect, the communication circuit 102, therefore, can be configured to transmit or receive data to and from the CMDs 108 (FIG. 8) and/or other MMDs 102 of the cluster 100 (FIGS. 1-5) via a directional or omnidirectional antenna, a microcontroller or FPGA, and via modulation/demodulation hardware for encoding data via carrier waves.

According to FIG. 11B, the payload 1104 can be configured for modular integration into the MMD 102 via the port 1106, which can be configured to electrically and mechanically couple the payload 1104 to the MMD 102. The payload 1104, therefore, may be one of a plurality of different payloads configured for use with the MMD 102 and selected based on relevance to the user-defined objective. The port 1106, therefore, can be universally configured to electrically and mechanically couple each of the plurality of different payloads to the MMD 102. However, according to some non-limiting aspects, the payload 1104 can be an integral or semi-permanent (welded, fastened, etc.) component of the MMD 102.

As previously described, the plurality of different payloads configured for use with the MMD 102 and universally adapted for use with the port 1106 can include, for example, sensing payloads, which can include camera systems (e.g., RGB, thermal, infrared, multispectral), LiDAR scanning, global positioning system (“GPS”) sensors, environmental sensors (e.g., air quality, gas detection, radiation), RFID tags and/or scanners, hyperspectral cameras, magnetometers, surveying tools (e.g., tool stations, laser scanners), sound or acoustic sensors, and/or ground penetrating radars. However, according to other non-limiting aspects, the plurality of different payloads can include interactive payloads, including sprayers (e.g., liquid, foam, powder, etc.), robotic arms and/or actuators, cranes or other payload delivery mechanisms, communication systems, lights, lasers, or beacons for visibility in low-light conditions or signaling, and/or thermal desorption systems to remove volatile contaminants, autonomous landing systems for precision landings, amongst other payloads that can be mixed and matched to tailor the cluster 100 to accomplish a variety of different user-defined objectives.

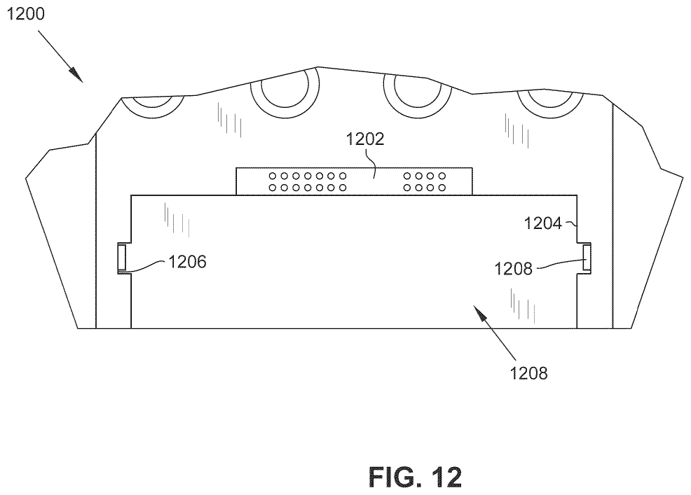

Referring now to FIG. 12, a port 1200 configured to mechanically and electrically couple any of a plurality of modular, interchangeable payloads to the vehicles of FIGS. 8 and 10 is depicted according to at least one non-limiting aspect of the present disclosure. The port 1200 is representative of the port 906 (FIG. 9B) of the CMD 108 (FIG. 9B) and the port of the 1106 (FIG. 11B) of the MMD 102 (FIG. 11B). According to the non-limiting aspect of FIG. 12, the port 1200 can include an electrical interface 1202, which can include one or more electrically conductive pins configured to convey power and/or data between a modular payload and the CMD 108 (FIG. 8) or the MMD 102 (FIG. 10). For example, the electrical interface 1202 can include a universal serial bus connector, a power of Ethernet connector, a magnetic connector, a Pixhawk connector, a PC104/PCIe Mini or M.2 connector, a SmartBatter SMbus, a UART connector, an I2C connector, an SPI connector, a CAN bus, a JST connector, an XT30/XT60/XT90 connector, a micro-fit or mini-fit connector, a pogo pin or spring contact, and/or a universal serial bus connector, amongst others.

From a mechanical perspective, the port 1200 of FIG. 12 can further include a cavity 1207 defined within the housing 806 (FIG. 8) of the CMD 108 (FIG. 8) or the hull 1008 (FIG. 10) of the MMD 102 (FIG. 10). The cavity 1207 can include a geometry that is substantially inverse relative to a geometry employed by each payload of a plurality of modular payloads configured for installation within the port 1200. In other words, the cavity 1207 can ensure that, when properly installed, a modular payload has a secure, mechanical fit within the housing 806 (FIG. 8) of the CMD 108 (FIG. 8) or the hull 1008 (FIG. 10) of the MMD 102 (FIG. 10). This can reduce unintended mechanical perturbations to an installed payload as the CMD 108 (FIG. 8) or MMD 102 (FIG. 10) traverses the operating environment 101 (FIGS. 1 and 2). However, the port can further include a first mechanical component 1204 and/or a second mechanical component 1206. The first mechanical component 1204 and the second mechanical component 1206 can include recesses of substantially inverse geometry to corresponding protrusions on each payload of the plurality of modular payloads.

As will be described in further detail herein, at least one of the corresponding protrusions on each payload of a plurality of modular payloads can be biased via a spring in an extended position, but depressed. Thus, the protrusions can be inserted within the first mechanical component 1204 and the second mechanical component 1206 and, therefore, each payload of a plurality of modular payloads can be secured within the 1208 of the CMD 108 (FIG. 8) or MMD 102 (FIG. 10). When properly secured within the 1208 of the CMD 108 (FIG. 8) or MMD 102 (FIG. 10), a corresponding electrical interface of each payload of a plurality of modular payloads can establish electrical contact with the electrical interface 1202 of the port 1200. Accordingly, a control circuit of the CMD 108 (FIG. 8) or MMD 102 (FIG. 10) can transmit signals and control the properly installed payload. As depicted in FIG. 12, at least the first mechanical component 1204 can include a button 1208 that, when electrically actuated or manually depressed from an exterior surface of the CMD 108 (FIG. 8) or MMD 102 (FIG. 10), can cause a corresponding protrusion of the installed payload to depress, which releases the payload from the port 1200, enabling a new payload of the plurality of modular payloads to be installed.

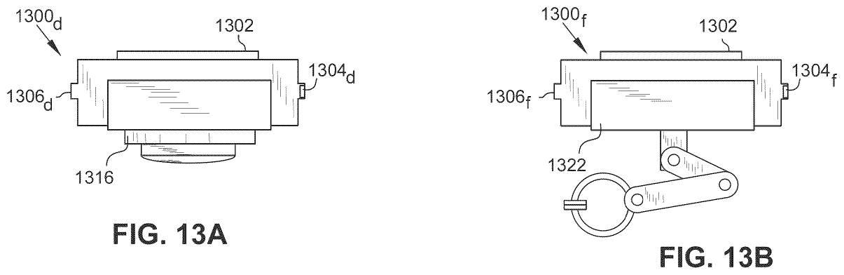

Referring now to FIGS. 13A and 13B, two modular, interchangeable payloads 1300_{d}, 1300_{f} configured for use with the port of FIG. 12 are respectively depicted according to at least one non-limiting aspect of the present disclosure. The interchangeable payloads 1300_{d}, 1300_{f} of FIGS. 13A and 13B are merely non-limiting examples of payloads from the plurality of modular payloads contemplated herein. It shall be appreciated that any payload described herein but not depicted in FIGS. 13A and 13B can be similarly configured for use with the port of FIG. 12. For example, the each of the interchangeable payloads 1300_{g}, 1300_{f} can include a first protrusion 1304_{d}, 1304_{f} and a second protrusion 1306_{d}, 1306_{f}. At least the first protrusion 1304_{d}, 1304_{f} can be spring biased into an extended position, as depicted in FIGS. 13A and 13B but configured to depressed in response to a manual and/or electronic input. When the first protrusion 1304_{d}, 1304_{f} is depressed, the second protrusion 1306_{d}, 1306_{f} can be installed into the corresponding second mechanical component 1206 (FIG. 12) of the port 1200. The body of the payload 1300_{d}, 1300_{f} can be subsequently inserted into the cavity 1207 of the port 1200 (FIG. 12) and, when the first protrusion 1304_{d}, 1304_{f} arrives at the first mechanical component 1204 (FIG. 12), the spring bias will cause it to extend into the cavity of the first mechanical component 1204 (FIG. 12), securing the payload 1300_{g}, 1300_{f} within the cavity 1207 of the port 1200 (FIG. 12). Each payload 1300_{g}, 1300_{f} can further include an electrical interface 1302 with a pin configuration that corresponds to the electrical interface 1202 (FIG. 12) of the port 1200 (FIG. 12). Thus, when the payload 1300_{d}, 1300_{f} is properly secured within the cavity 1207 of the port 1200 (FIG. 12), the electrical interface 1302 of the payload 1300_{d}, 1300_{f} establishes electrical contact with the electrical interface 1202 (FIG. 12) of the port 1200 (FIG. 12).

According to FIG. 13A, a first payload 1300_{g} can include an enhanced surveillance payload 1316 configured to be activated by the control circuit 104 of the MMD 102. The enhanced surveillance payload 1316 can be configured with additional, objective-specific sensing capabilities, including the visual and audible sensing devices disclosed herein. According to FIG. 13B, a second payload 1300, can include a robotic payload 1322 configured to be activated by the control circuit 104 of the MMD 102. The robotic payload 1322 can include one or more articulating joints and/or an end effector configured to open and close. For example, the robotic payload 1322 can be configured for three-dimensional articulation such that the end effector can interact with targets within the operating environment 101.

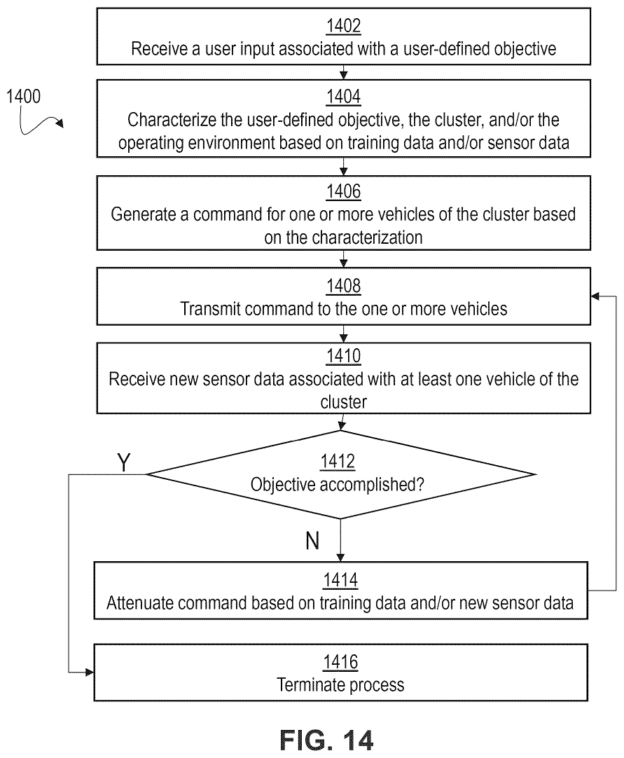

Referring now to FIG. 14, a method 1400 of dynamically generating and updating commands for one or more autonomous vehicles within a cluster based on real-time sensor data is depicted according to at least one non-limiting aspect of the present disclosure. For example, according to some non-limiting aspects, one or more steps of the method 1500 can be performed by a CMD 108ₐ, 108_{b} (FIG. 1) upon execution of a MMCD model 114 (FIG. 3) stored in a memory 112ₐ, 112_{b} via a control circuit 110ₐ, 110_{b} of the CMD 108ₐ, 108_{b}. However, according to other non-limiting aspects, one or more steps of the method 1500 can be performed by a CCA 302 (FIG. 3) upon execution of an MMCD model 114 (FIG. 3) stored in a memory 306 (FIG. 3) and executed by a control circuit 304 (FIG. 3) associated with the CCA 302 (FIG. 3).

According to FIG. 14, the method 1400 can include receiving 1402 a user input associated with a user-defined objective. The MMCD model 114 (FIGS. 1 and 3) may be trained with various types of data and sensor data that correlates to numerous user-defined objectives, operating environments 101 (FIGS. 1 and 2), conditions within such operating environments 101 (FIGS. 1 and 2), configurations of autonomous vehicles within the cluster 101, payloads of such autonomous vehicles, amongst other types of training data. Accordingly, based on the training data and/or initial sensor data received by the MMCD model 114, the method 1400 can further include characterizing 1404 the user-defined objective, the cluster, and/or the operating environment. In other words, the MMCD model 114 (FIGS. 1-3) can be trained to autonomously determine what the user wants the vehicles of the cluster 100 (FIGS. 1 and 2) to collectively accomplish within the operating environment 101 (FIGS. 1-3) as well as a condition of the various vehicles of the cluster 100 (FIGS. 1 and 2) and a condition of the operating environment 101 (FIGS. 1-3). Based on this characterization, the method 1400 can include generating 1406 a command for one or more vehicles of the cluster 100 (FIGS. 1 and 2) and transmitting 1408 the generated command to the one or more vehicles of the cluster 100 (FIGS. 1 and 2).

The method 1400 can further include receiving 1410 new sensor data associated with first autonomous vehicle and determining 1412 whether the user-defined objective has been accomplished based on the new sensor data and the training data. For example, the MMCD model 114 (FIGS. 1 and 3) may be trained to determine that the new sensor data corresponds to a condition wherein the user-defined objective has been accomplished. If the objective has not been accomplished, the method 1400 can further include attenuating 1414 the command based on the received sensor data and again transmitting 1408 the attenuated command to the first autonomous vehicle, receiving 1410 sensor data, and determining 1412 if the objective has been accomplished. If the objective has been accomplished, the method 1400 can further include terminating 1416 the process.

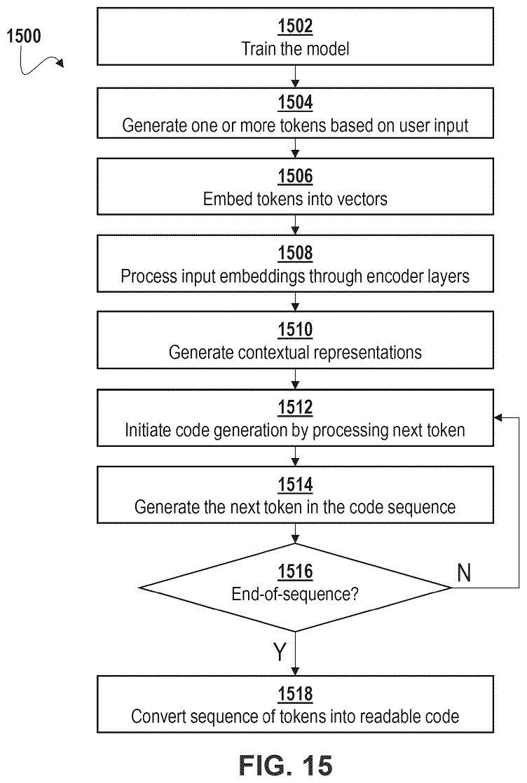

Referring now to FIG. 15, a method 1500 of training and using an MMCD model 114 (FIGS. 1 and 3) to perform the method 1400 of FIG. 14 is depicted according to at least one non-limiting aspect of the present disclosure. It shall be appreciated that, although the non-limiting aspect of FIG. 15 illustrates the use of a transformer-based model to generate the commands using language modeling and task-generation for output code, the present disclosure contemplates other non-limiting aspects that use other models to generate the commands, including sequence-to-sequence models (e.g., for machine translation), attention mechanisms (e.g., to understand context), recurrent neural networks (e.g., to generate code and create code structure), long short-term memory networks, reinforcement learning models (e.g., to fine-tune and optimize code), generational adversarial networks (e.g., to generate and discriminate code to promote accuracy), and/or variational autoencoders (e.g., to compress data into a latent space), amongst others. According to other non-limiting aspects, a hybrid model may be used, combining aspects of other models to achieve the same effect.

According to the non-limiting aspect of FIG. 15, the method 1500 can include training 1502 the MMCD model 114 (FIGS. 1-3) using a data set relevant to the operating environment 101 (FIGS. 1-3), various user-defined objectives, vehicles of the cluster, their respective payloads, and/or sensor data generated by such vehicles. It shall be appreciated that the data set used to train the MMCD model 114 (FIGS. 1-3) can include sensor data, maps, specifications, and/or additional information. The data set can be cleaned, normalized, and transformed into a format the algorithm can process. For example, according to the non-limiting aspect of FIG. 15, wherein the model includes a transformer, the data set can be presented via a self-attention mechanism such that the AI model can weigh the importance of different parts of the input sequence and learn complex relationships within the data set. However, according to the non-limiting aspect wherein the model includes a generational adversarial network, the data set can be fake data generated by the generator sub-model and the discriminator sub-model can evaluate the data against real data provided by the user. The generator, therefore, can improve in order to fool the discriminator. Wherein a variational autoencoder is used, the model can encode data into a latent space and decode it back, minimizing the difference between the original and generated data. The data set can be either manually presented to the AI model or autonomously generated and presented to the AI model via a control loop performed by the system 100 (FIG. 1).

Once the AI model is trained, the method 1500 of FIG. 15 can further include, based on the received 1402 (FIG. 14) user input, generating 1504 one or more tokens (e.g., small units of text) based on the user input. The user input can not only include information associated with the user-defined objective, but also a number of vehicles of the cluster, their respective payloads, and/or sensor data generated by such vehicles and/or one or more management authority protocols. The method 1500 can further include embedding 1506 the tokens into high-dimensional vectors using pre-trained embeddings and processing 1508 the input embeddings through encoder layers of the transformer model. It shall be appreciated that each layer can apply self-attention and feed-forward neural network techniques to derive contextual information from the user input. Once processed, the method 1500 can further include generating 1510 contextual representations (e.g., unlike static representations) of the input tokens, which can dynamically provide context of a token based on its use and relationship to other tokens generated based on the user input, providing context for the objective, or protocols requested. It shall be appreciated that these can allow the model to understand the meaning and relationships of the inputs provided via the user input.

The method 1500 of FIG. 15 can further include initiating 1512 the code generation process by processing the input embeddings through the encoder layers of the transformer model. Each layer of the model, for example, can apply self-attention and encoder-decoder attention mechanisms to predict the next token. The method 504 can further include continuing the code generation by generating 1514 the next token in the code sequence based on the data set provided via training 1502 and predicting the next token based on the decoder's output. Eventually, the method 1500 can include checking 1516 if the code is at the end-of-sequence, having accounted for each token and therefore, each parameter within the user input. If the code is not at the end-of-sequence, the method 1500 can include initiating 1512 the code generation once more by processing the next token. If the code is at the end-of-sequence, the method 1500 can include the process of detokenization by converting 1518 the sequence of tokens into readable code.

Examples of the methods and systems disclosed herein, according to various aspects of the present disclosure, are provided below in the following embodiments. An aspect of the methods may include any one or more than one of, and any combination of, the embodiments described below.
Clause 1. A method of dynamically generating and updating commands for a cluster of autonomous vehicles to accomplish a user-defined objective within an operating environment, the method including receiving, via a Modular Micro Cluster Drone (“MMCD”) model, a user input associated with the user-defined objective, characterizing, via the MMCD model, the user-defined objective, the cluster of autonomous vehicles, or the operating environment, or combinations thereof based on training data, generating, via the MMCD model, a command for one or more vehicles of the cluster based on the characterization, transmitting, via the MMCD model, the command to at least one vehicle of the cluster of autonomous vehicles, receiving, via the MMCD model, sensor data associated with the cluster of autonomous vehicles, and determining, via the MMCD model, whether the user-defined objective has been accomplished based on the sensor data associated with the cluster of autonomous vehicles.
Clause 2. The method according to clause 1, further including determining, via the MMCD model, that the user-defined objective has not been accomplished based on the sensor data generated by the at least one vehicle of the cluster of autonomous vehicles
Clause 3. The method according to either of clauses 1 or 2, further including attenuating, via the MMCD model, the command based on the sensor data generated by the at least one vehicle of the cluster of autonomous vehicles.
Clause 4. The method according to any of clauses 1-3, further including determining, via the MMCD model, that the user-defined objective has been accomplished based on the sensor data generated by the at least one vehicle of the cluster of autonomous vehicles.
Clause 5. The method according to any of clauses 1-4, further including terminating, via the MMCD model, the method based on the determination that the user-defined objective has been accomplished.
Clause 6. The method according to any of clauses 1-5, further including receiving, via the MMCD model, initial sensor data from the cluster of autonomous vehicles, wherein the characterization is further based on the initial sensor data received from the cluster of autonomous vehicles.
Clause 7. The method according to any of clauses 1-6, wherein the at least one vehicle of the cluster of autonomous vehicles includes a Modular Micro Drone Unit (“MMD”), and wherein transmitting the command to the at least one vehicle of the cluster of autonomous vehicles includes transmitting the command from a Communication Micro Drone Unit (“CMD”) to the MMD.
Clause 8. The method according to any of clauses 1-7, further including communicatively coupling the CMD and the MMD via a short range network.
Clause 9. The method according to any of clauses 1-8, wherein the command is transmitted from the CMD to the MMD via the short range network.
Clause 10. The method according to any of clauses 1-9, wherein transmitting the command to the at least one vehicle of the cluster of autonomous vehicles further includes transmitting the command from a Centralized Command Authority (“CCA”) to the CMD.
Clause 11. The method according to any of clauses 1-10, further including communicatively coupling the CCA and the CMD via a long range network.
Clause 12. The method according to any of clauses 1-11, wherein the command is transmitted from the CCA to the CMD via the long range network.
Clause 13. A system configured to dynamically generate and update commands for a cluster of autonomous vehicles to accomplish a user-defined objective within an operating environment, the system including a control circuit and a memory communicatively coupled to the control circuit, wherein the memory stores a Modular Micro Cluster Drone (“MMCD”) model that, when executed by the control circuit, causes the system to receive a user input associated with the user-defined objective, characterize the user-defined objective, the cluster of autonomous vehicles, or the operating environment, or combinations thereof based on training data, generate a command for one or more vehicles of the cluster based on the characterization, establish a short range network that communicatively couples the MMCD model to at least one vehicle of the cluster of autonomous vehicles, transmit the command to the at least one vehicle of the cluster of autonomous vehicles via the short range network, receive sensor data associated with the cluster of autonomous vehicles, and determine whether the user-defined objective has been accomplished based on the sensor data associated with the cluster of autonomous vehicles.
Clause 14. The system according to clause 13, wherein, when executed by the control circuit, the MMCD model further causes the system to determine that the user-defined objective has not been accomplished based on the sensor data generated by the at least one vehicle of the cluster of autonomous vehicles.
Clause 15. The system according to either of clauses 13 or 14, wherein, when executed by the control circuit, the MMCD model further causes the system to attenuate the command based on the sensor data generated by the at least one vehicle of the cluster of autonomous vehicles.
Clause 16. The system according to any of clauses 13-15, wherein, when executed by the control circuit, the MMCD model further causes the system to determine that the user-defined objective has been accomplished based on the sensor data generated by the at least one vehicle of the cluster of autonomous vehicles.
Clause 17. A method of dynamically generating and updating commands for a cluster of autonomous vehicles to accomplish a user-defined objective within an operating environment, the method including receiving, via a Modular Micro Cluster Drone (“MMCD”) model, a user input associated with the user-defined objective, generating, via the MMCD model, a command for one or more vehicles of the cluster based on the user input, receiving, via the MMCD model, sensor data associated with the cluster of autonomous vehicles, and determining, via the MMCD model, whether the user-defined objective has been accomplished based on the sensor data associated with the cluster of autonomous vehicles.
Clause 18. The method according to clause 17, further including determining, via the MMCD model, that the user-defined objective has not been accomplished based on the sensor data associated with the cluster of autonomous vehicles.
Clause 19. The method according to either of clauses 17 or 18, further including attenuating, via the MMCD model, the command based on the sensor data associated with the cluster of autonomous vehicles.
Clause 20. The method according to any of clauses 17-19, further including determining, via the MMCD model, that the user-defined objective has been accomplished based on the sensor data associated with the cluster of autonomous vehicles.

All patents, patent applications, publications, or other disclosure material mentioned herein, are hereby incorporated by reference in their entirety as if each individual reference was expressly incorporated by reference, respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications, or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may be performed in any order. Also, although claim recitations are presented in a sequence(s), it should be understood that the various operations may be performed in other orders than those which are described or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a,” “an,” and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements but is not limited to possessing only those one or more elements. Likewise, an element of a system, device, or apparatus that “comprises,” “has,” “includes” or “contains” one or more features possesses those one or more features but is not limited to possessing only those one or more features.

Instructions used to program logic to perform various disclosed aspects can be stored within a memory in the system, such as dynamic random-access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random-access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microcontroller configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations. Software may be embodied as a software package, code, instructions, instruction sets and/or data recorded on non-transitory computer readable storage medium. Firmware may be embodied as code, instructions or instructions sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard,” published in December 2008 and/or later versions of this standard. Alternatively, or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively, or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively, or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different, and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can encompass active-state components and/or inactive-state components and/or standby-state components unless context requires otherwise.

The terms “proximal” and “distal” are used herein with reference to a clinician manipulating the handle portion of the surgical instrument. The term “proximal” refers to the portion closest to the clinician and the term “distal” refers to the portion located away from the clinician. It will be further appreciated that, for convenience and clarity, spatial terms such as “vertical,” “horizontal,” “up,” and “down” may be used herein with respect to the drawings. However, surgical instruments are used in many orientations and positions, and these terms are not intended to be limiting and/or absolute.

1. A method of dynamically generating and updating commands for a cluster of autonomous vehicles to accomplish a user-defined objective within an operating environment, the method comprising:
receiving, via a Modular Micro Cluster Drone (“MMCD”) model, a user input associated with the user-defined objective;
characterizing, via the MMCD model, the user-defined objective, the cluster of autonomous vehicles, or the operating environment, or combinations thereof based on training data;
generating, via the MMCD model, a command for one or more vehicles of the cluster based on the characterization;
transmitting, via the MMCD model, the command to at least one vehicle of the cluster of autonomous vehicles via a Communication Micro Drone (“CMD”) Unit;
receiving, via the MMCD model, sensor data associated with the cluster of autonomous vehicles; and
determining, via the MMCD model, whether the user-defined objective has been accomplished based on the sensor data associated with the cluster of autonomous vehicles, wherein the at least one vehicle of the cluster of autonomous vehicles comprises a Modular Micro Drone Unit (“MMD”), and wherein transmitting the command to the at least one vehicle of the cluster of autonomous vehicles comprises transmitting the command from the CMD to the MMD.

2. The method of claim 1, further comprising determining, via the MMCD model, that the user-defined objective has not been accomplished based on the sensor data associated with the cluster of autonomous vehicles.

3. The method of claim 2, further comprising attenuating, via the MMCD model, the command based on the sensor data associated with the cluster of autonomous vehicles.

4. The method of claim 1, further comprising determining, via the MMCD model, that the user-defined objective has been accomplished based on the sensor data associated with the cluster of autonomous vehicles.

5. The method of claim 4, further comprising terminating, via the MMCD model, the method based on the determination that the user-defined objective has been accomplished.

6. The method of claim 1, further comprising receiving, via the MMCD model, initial sensor data from the cluster of autonomous vehicles, wherein the characterization is further based on the initial sensor data received from the cluster of autonomous vehicles.

7. (canceled)

8. The method of claim 1, further comprising:
communicatively coupling the CMD and the MMD via a short range network.

9. The method of claim 8, wherein the command is transmitted from the CMD to the MMD via the short range network.

10. The method of claim 1, wherein transmitting the command to the at least one vehicle of the cluster of autonomous vehicles further comprises transmitting the command from a Centralized Command Authority (“CCA”) to the CMD.

11. The method of claim 10, further comprising:
communicatively coupling the CCA and the CMD via a long range network.

12. The method of claim 11, wherein the command is transmitted from the CCA to the CMD via the long range network.

13-20. (canceled)
